(19) United States
(12) Patent Application Publication
(10) Pub. No.: US 2024/0336113 A1
(43) Pub. Date: Oct. 10, 2024

(54) METHOD FOR CONTROLLING AN AIR HANDLING SYSTEM

(71) Applicant: Hanon Systems, Daejeon (KR)

(72) Inventors: Eric K. Haupt, Livonia, MI (US); Mark Douglas Conley, Canton, MI (US); Jennifer Petrowski, Royal Oak, MI (US); Shane Harte, Novi, MI (US)

(21) Appl. No.: 18/625,320

(22) Filed: Apr. 3, 2024

Related U.S. Application Data
(60) Provisional application No. 63/494,917, filed on Apr. 7, 2023.

(51) Int. Cl. B60H 1/00

(52) U.S. Cl. CPC B60H 1/00835

(57) ABSTRACT

A control method for an HVAC system of a vehicle including an air handling system having a dual inlet design is disclosed. The air handling system comprises a housing having recirculation air inlets to receive recirculation air originating from a passenger compartment of the vehicle, ambient air inlets to receive ambient air originating from an ambient environment, and a blower assembly that causes air to flow through the housing. Distribution doors and baffle doors selectively control a flow of the recirculation air and the ambient air into the housing. The control method selectively positions the distribution doors and the baffle doors and selectively adjusts a speed of the blower assembly to achieve a target dew point temperature in a passenger compartment of the vehicle.

### CROSS-REFERENCE TO RELATED APPLICATION

This application claims the benefit of U.S. Provisional Patent Application Ser. No. 63/494,917, filed Apr. 7, 2023, the entirety of which is herein incorporated by reference.

### FIELD

The invention relates to a heating, ventilation, and air-conditioning (HVAC) system, and more particularly to a method for controlling an dual inlet air handling system of the HVAC system.

### BACKGROUND

Introduction of electric and hybrid electric vehicles has resulted in the need for energy conservation with respect to various different systems of the associated vehicles. With regard to an HVAC system of such vehicles, it may be necessary to recirculate previously-conditioned air present within the passenger compartment in order to improve an efficiency of the HVAC system. This occurs because the previously-conditioned air is typically already in a heated or cooled state in comparison to an ambient environment. Hence, the HVAC system requires a decreased heating or cooling input when conditioning the recirculation air originating from the passenger compartment. However, the exclusive use of recirculation air originating from the passenger compartment can introduce undesirable fogging on an interior surface of windows of the vehicle during various operational modes of the HVAC system. Such fogging of the vehicle windows occurs because each breath taken in by passengers of the vehicle adds moisture to the air being recirculated, and thereby increase a humidity level within the passenger compartment.

In order to prevent such occurrences, it may be desirable to introduce ambient air to the HVAC system in addition to or in place of the recirculation air. The use of a combination of a partial flow of ambient air and a partial flow of recirculation air accordingly reduces the risk of fogging of the vehicle windows, which in turn improves vehicle safety.

Commonly known HVAC systems include an air handling system having a housing that defines a flow path for the ambient air to flow through when being conditioned and then distributed to the passenger compartment through various vents. The air handling system typically may include an air inlet section where air first enters before being distributed to a conditioning section thereof. The air inlet section may include at least an ambient air inlet and a recirculation air inlet that can each be used to introduce the air into the conditioning section. An distribution door controls the distribution of the air entering from the ambient air inlet and the recirculation air inlet. For example, the distribution door may be adjustable between a first position wherein the ambient air inlet is completely open while the recirculation air inlet is completely closed, a second position wherein the ambient air inlet is completely closed while the recirculation air inlet is completely open, and a plurality of intermediate positions wherein the distribution door adjustably controls a distribution of the air originating from the ambient air inlet and the recirculation air inlet. The ambient air inlet and the recirculation air inlet typically each lead to an air filter and a downstream blower assembly. A suction pressure generated by the blower assembly causes the air within the air inlet section to flow in a direction through the air filter and towards a blower wheel of the blower assembly. The air then exits the blower assembly and flows towards the conditioning section of the air handling system where the air is conditioned and distributed to the various vents of the vehicle based on a passenger selected mode of operation of the HVAC system.

Conventional air handling systems may employ a single distribution door within the air inlet section. Use of only one distribution door can disadvantageously cause an unintended and undesirable condition when attempting to introduce a combination of ambient and recirculation air into the conditioning section of the air handling system through the air inlet section. The distribution door allows for an open flow path to be provided between the ambient air inlet and the recirculation air inlet when the distribution door is in one of the intermediate positions. Under some circumstances, however, the use of the single distribution door can lead to a situation where a velocity of the vehicle causes an increase of ram air pressure, which thereby causes an increase in an amount of the ambient air introduced to the air inlet section. As the ram air pressure increases, a likelihood of the ambient air reaching a pressure sufficient for causing an undesirable amount of the ambient air to flow past the distribution door and towards the conditioning section similarly increases.

The introduction of the undesired amount of the ambient air into the conditioning section of the air handling system decreases the efficiency of the HVAC system by introducing unconditioned air into the conditioning section that must in turn be conditioned, which in turn increases a thermal load placed on the HVAC system when attempting to achieve the desired conditioning of the air being delivered to the passenger compartment. This increase in thermal load increases an amount of energy that is consumed by the HVAC system to condition the air to in accordance with the requirements of the passenger of the vehicle. Such flow of the undesired amount of the ambient air into the air inlet section also decreases the ability of the HVAC system to regulate the temperature and humidity level of the air within the passenger compartment, thereby negatively affecting the comfort of the passenger.

Accordingly, it would be desirable to develop an improved method of controlling an air handling system for an HVAC system capable of regulating the airflow between the ambient air inlet and the recirculation air inlet to optimize performance, effectiveness, and efficiency of the HVAC system.

### SUMMARY

In concordance and agreement with the present invention, an improved method of controlling an air handling system for an HVAC system capable of regulating the airflow between the ambient air inlet and the recirculation air inlet to optimize performance, effectiveness, and efficiency of the HVAC system, has surprisingly been discovered.

In one embodiment, a method of operating an air handling system of a vehicle comprises the steps of: providing a housing defining an inlet section and a conditioning section downstream of the inlet section, wherein the inlet section includes one or more distribution doors and one or more baffle doors disposed therein to selectively control a flow of recirculation air and a flow of ambient air entering the inlet section, and wherein the conditioning section includes a blower assembly; selectively positioning at least one of the doors to selectively control the flow of the recirculation air and the ambient air through the inlet section; and selectively controlling a speed of the blower assembly to achieve a target dew point temperature in a passenger compartment of the vehicle.

In another embodiment, a method of operating an air handling system of a vehicle comprises the steps of: providing a housing defining an inlet section and a conditioning section downstream of the inlet section, wherein the inlet section includes a first inlet portion and a second inlet portion, wherein the first inlet portion includes a first recirculation air inlet configured to receive recirculation air originating from a passenger compartment of the vehicle and a first ambient air inlet configured to receive ambient air originating from an ambient environment, wherein the second inlet portion includes a second recirculation air inlet configured to receive recirculation air originating from the passenger compartment of the vehicle and a second ambient air inlet configured to receive the ambient air originating from the ambient environment, wherein the first distribution door and the first baffle door are disposed in the inlet section and configured to selectively control a flow of the recirculation air and the ambient air entering the first inlet portion through the first recirculation air inlet and the first ambient air inlet, wherein the second distribution door and the second baffle door are disposed in the inlet section and configured to selectively control a flow of the recirculation air and the ambient air entering the second inlet portion through the second recirculation air inlet and the second ambient air inlet, and wherein the conditioning section includes a blower assembly; selectively positioning of at least one of the first distribution door, the second distribution door, the first baffle door, and the second baffle door to selectively control the flow of the recirculation air and the ambient air through the inlet section, wherein: when the air handling system is operating in a recirculation mode, each of the first distribution door and the first baffle door is in a first position to militate against the flow of the ambient air through the first ambient air inlet and each of the second distribution door and the second baffle door is in a first position to militate against the flow of the ambient air through the second ambient air inlet; when the air handling system is operating in an ambient air mode, each of the first distribution door and the first baffle door is in a second position to militate against the flow of the recirculation air through the first recirculation air inlet, and the second distribution door and the second baffle door is in a second position to militate against the flow of the recirculation air through the second recirculation air inlet; and when the air handling system is operating in a partial recirculation mode, at least one of the first distribution door and the first baffle door is in an intermediate position between the first and second positions to selectively control the flow of the recirculation air through the first recirculation air inlet and/or the ambient air through the first ambient air inlet and at least one of the second distribution door and the second baffle door is in an intermediate position between the first and second positions to selectively control the flow of the recirculation air through the second recirculation air inlet and/or the ambient air through the second ambient air inlet; and selectively controlling a speed of a blower assembly to achieve a target dew point temperature in a passenger compartment of the vehicle.

In yet another embodiment, a method of operating an air handling system of a vehicle comprises the steps of: providing a housing defining an inlet section and a conditioning section downstream of the inlet section, wherein the inlet section includes a first inlet portion and a second inlet portion, wherein the first inlet portion includes a first recirculation air inlet configured to receive recirculation air originating from a passenger compartment of the vehicle and a first ambient air inlet configured to receive ambient air originating from an ambient environment, wherein the second inlet portion includes a second recirculation air inlet configured to receive recirculation air originating from the passenger compartment of the vehicle and a second ambient air inlet configured to receive the ambient air originating from the ambient environment, wherein the first distribution door and the first baffle door are disposed in the inlet section and configured to selectively control a flow of the recirculation air and the ambient air entering the first inlet portion through the first recirculation air inlet and the first ambient air inlet, wherein the second distribution door and the second baffle door are disposed in the inlet section and configured to selectively control a flow of the recirculation air and the ambient air entering the second inlet portion through the second recirculation air inlet and the second ambient air inlet, and wherein the conditioning section includes a blower assembly; selectively positioning of at least one of the first distribution door, the second distribution door, the first baffle door, and the second baffle door to selectively control the flow of the recirculation air and the ambient air through the inlet section, wherein: when the air handling system is operating in a recirculation mode, each of the first distribution door and the first baffle door is in a first position to militate against the flow of the ambient air through the first ambient air inlet and each of the second distribution door and the second baffle door is in a first position to militate against the flow of the ambient air through the second ambient air inlet; when the air handling system is operating in an ambient air mode, each of the first distribution door and the first baffle door is in a second position to militate against the flow of the recirculation air through the first recirculation air inlet, and the second distribution door and the second baffle door is in a second position to militate against the flow of the recirculation air through the second recirculation air inlet; and when the air handling system is operating in a partial recirculation mode, the first distribution door and the first baffle door are in intermediate position between the first and second positions to selectively control the flow of the recirculation air through the first recirculation air inlet and the ambient air through the first ambient air inlet and the second distribution door and the second baffle door are in intermediate positions between the first and second positions to selectively control the flow of the recirculation air through the second recirculation air inlet and the ambient air through the second ambient air inlet; and selectively controlling a speed of a blower wheel of a blower assembly to achieve a target dew point temperature in a passenger compartment of the vehicle.

As aspects of some embodiments, at least one of the doors is in a first position to militate against the flow of the ambient air through the inlet section when the air handling system is operating in a recirculation mode.

As aspects of some embodiments, at least one of the doors is in a second position to militate against the flow of the recirculation air through the inlet section when the air handling system is operating in an ambient air mode.

As aspects of some embodiments, at least one of the doors is in an intermediate position between the first and second positions to selectively control the flow of the recirculation air and/or the flow of ambient air through the inlet section to achieve a desired ratio of the ambient air to the recirculation air when the air handling system is operating in a partial recirculation mode.

As aspects of some embodiments, the doors are in intermediate positions between the first and second positions to selectively control the flow of the recirculation air and the flow of ambient air through the inlet section to achieve a desired ratio of the recirculation air to the ambient air when the air handling system is operating in a partial recirculation mode.

As aspects of some embodiments, the selective positioning of the doors is symmetric and uniform when the air handling system is operating in an ambient air mode.

As aspects of some embodiments, the selective positioning of the doors is symmetric and non-uniform when the air handling system is operating in an ambient air mode.

As aspects of some embodiments, the selective positioning of the doors is asymmetric when the air handling system is operating in an ambient air mode.

As aspects of some embodiments, the target dew point temperature is in a range of about 5 degrees Celsius below a temperature of ambient air to about 15 degrees Celsius above the temperature of ambient air.

As aspects of some embodiments, the speed of the blower increases as at least one of a speed of the vehicle and a cowl pressure decreases.

As aspects of some embodiments, a desired percentage of total airflow of the recirculation air is in a range of about 25% to about 65% when the speed of the blower assembly is relatively low.

As aspects of some embodiments, a desired percentage of total airflow of the recirculation air is about 75% to about 85% when the speed of the blower assembly is relatively high.

As aspects of some embodiments, a desired percentage of total airflow of the recirculation air increases as the speed of the blower assembly increases.

As aspects of some embodiments, the speed of the blower assembly and a ratio of the recirculation air to the ambient air when the air handling system is operating in a partial recirculation mode is determined based upon at least one of a vehicle speed, a humidity level of air within the passenger compartment, a humidity level of conditioned air entering the passenger compartment, a humidity level of the recirculation air entering the recirculation air inlets, a humidity level of the ambient air entering the ambient air inlets, a temperature of the ambient air, and a number of occupants in the vehicle.

As aspects of some embodiments, an increase in energy consumption of the air handling system resulting from an increase in the speed of the blower assembly is offset by a decrease in energy consumption of a heater core of the air handling system.

As aspects of some embodiments, the doors have a finite number of positions for each operating mode of the air handling system.

As aspects of some embodiments, each of the doors has a single position for each operating mode of the air handling system.

As aspects of some embodiments, the doors have a plurality of positions for a partial recirculation mode of the air handling system.

### BRIEF DESCRIPTION OF THE DRAWINGS

The above-mentioned, and other features and objects of the inventions, and the manner of attaining them will become more apparent and the invention itself will be better understood by reference to the following description of embodiments of the invention taken in conjunction with the accompanying drawings, wherein:

FIG. 1 is a schematic top plan view of an electric vehicle including an HVAC system having an air handling system according to an embodiment of the present disclosure;

FIG. 2 is a fragmentary cross-sectional elevational view through an inlet section of the air handling system of FIG. 1, wherein the air handling system is operating in a recirculation mode of operation with a first distribution door and a first baffle door in first positions to militate against a flow of a fresh or ambient air through a first fresh or ambient air inlet and permit a flow of a recirculation air through a first recirculation air inlet of the inlet section and a second distribution door and a second baffle door in first positions to militate against a flow of a fresh or ambient air through a second fresh or ambient air inlet and permit a flow of a recirculation air through a second recirculation air inlet of the inlet section;

FIG. 3 is a fragmentary cross-sectional elevational view through the inlet section of the air handling system of FIG. 1, wherein the air handling system is operating in a fresh or ambient air mode of operation with the first distribution door and the first baffle door in second positions to permit the flow of the ambient air through the first ambient air inlet and militate against the flow of the recirculation air through the first recirculation air inlet of the inlet section and the second distribution door and the second baffle door in second positions to permit the flow of the ambient air through the second ambient air inlet and militate against the flow of the recirculation air through the second recirculation air inlet of the inlet section;

FIG. 4 is a fragmentary cross-sectional elevational view through the inlet section of the air handling system of FIG. 1, wherein the air handling system is operating in a restricted ambient air mode of operation of the air handling system with the first distribution door in the second position to militate against the flow of the recirculation air through the first recirculation air inlet of the inlet section and the first baffle door in an intermediate position towards the first position to permit a constricted flow of the ambient air through the first ambient air inlet of the inlet section and the second distribution door in the second position to militate against the flow of the recirculation air through the second recirculation air inlet of the inlet section and the second baffle door in an intermediate position towards the first position to permit a constricted flow of the ambient air through the second ambient air inlet of the inlet section;

FIG. 5 is a fragmentary cross-sectional elevational view through the inlet section of the air handling system of FIG. 1, wherein the air handling system is operating in a partial recirculation mode of operation with the first distribution door and the first baffle door in second positions to permit the flow of the ambient air through the first ambient air inlet and militate against the flow of the recirculation air through the first recirculation air inlet of the inlet section and the second distribution door and the second baffle door in the first positions to militate against the flow of the ambient air through the second ambient air inlet and permit the flow of the recirculation air through the second recirculation air inlet of the inlet section;

FIG. 6 is a fragmentary cross-sectional elevational view through the inlet section of the air handling system of FIG. 1, wherein the air handling system is operating in a partial recirculation mode of operation with the first distribution door and the first baffle door in the first positions to militate against the flow of the ambient air through the first ambient air inlet and permit the flow of the recirculation air through the first recirculation air inlet of the inlet section and the second distribution door and the second baffle door in the second positions to permit the flow of the ambient air through the second ambient air inlet and militate against the flow of the recirculation air through the second recirculation air inlet of the inlet section;

FIG. 7 is a fragmentary cross-sectional elevational view through the inlet section of the air handling system of FIG. 1, wherein the air handling system is operating in a partial recirculation mode of operation with the first distribution door and the first baffle door in the second positions to militate against the flow of the recirculation air through the first recirculation air inlet of the inlet section and the second distribution door in the first position to militate against the flow of the ambient air through the second ambient air inlet of the inlet section and the second baffle door in an intermediate position to permit a constricted flow of the recirculation air through the second recirculation air inlet of the inlet section;

FIG. 8 is a fragmentary cross-sectional elevational view through the inlet section of the air handling system of FIG. 1, wherein the air handling system is operating in a partial recirculation mode of operation with the first distribution door in the second position to militate against the flow of the recirculation air through the first recirculation air inlet of the inlet section and the first baffle door in the intermediate position towards the first position to permit a constricted flow of the ambient air through the first ambient air inlet of the inlet section and the second distribution door in the first position to militate against the flow of the ambient air through the second ambient air inlet of the inlet section and the second baffle door in an intermediate position to permit a constricted flow of the recirculation air through the second recirculation air inlet of the inlet section;

FIG. 9 is a front elevational view of the distribution doors and the baffle doors according to an embodiment of the presently disclosed subject matter, wherein the doors are shown in isolation from the remainder of the air handling system of FIG. 1;

FIG. 10 is a perspective view of the distribution doors of FIG. 9;

FIG. 11 is a perspective view of the baffle doors according to an embodiment of the presently disclosed subject matter, wherein the doors are shown in isolation from the remainder of the air handling system of FIG. 1 and include a pair of sealing elements;

FIG. 12 is a schematic cross-sectional view of the air handling system of the FIG. 1, wherein the air handling system includes an inlet section, a conditioning section downstream of the inlet section, a mixing section downstream of the conditioning section, and a distribution section downstream of the mixing section;

FIG. 13 is a graph of vehicle interior dew point versus recirculation percentage at −20 degrees Celsius for a partial recirculation zone of operation at low blower volume operation and high blower volume operation, showing a maximum desired dew point temperature and a minimum desired dew point temperature and showing a low blower volume recirculation percentage zone of control and a high blower volume recirculation percentage zone of control. At low blower volume operation and high blower volume operation, the dew point temperature is impacted by the amount of fresh air intake to the vehicle;

FIG. 14 is a graph showing blower control/current versus cowl pressure during prior art operational control of an air handling system for a vehicle;

FIG. 15 is graph showing actual recirculation percentage as ram pressure/vehicle speed changes for various target recirculation percentages having different door positions of an air handling system at low blower speed using a prior art operational control method for the air handling system;

FIG. 16 is a graph showing blower control/current versus cowl pressure during exemplary operational control of an air handling system for a vehicle according to the present disclosure;

FIG. 17 is a graph showing actual recirculation percentage as ram pressure/vehicle speed changes for various target recirculation percentages having different door positions of an air handling system at low blower speed using an operational control method for the air handling system according to an embodiment of the present disclosure;

FIGS. 18A and 18B are graphs showing door positions of the air handling system of FIG. 1 during an ambient air mode when using symmetric and uniform control of the distribution and baffle doors thereof; and

FIGS. 19A and 19B are graphs showing door positions of the air handling system of FIG. 1 during an ambient air mode when using symmetric and non-uniform control of the distribution and baffle doors thereof.

### DETAILED DESCRIPTION

The following description of technology is merely exemplary in nature of the subject matter, manufacture and use of one or more disclosures, and is not intended to limit the scope, application, or uses of any specific disclosure claimed in this application or in such other applications as may be filed claiming priority to this application, or patents issuing therefrom. Regarding methods disclosed, the order of the steps presented is exemplary in nature, and thus, the order of the steps can be different in various embodiments. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

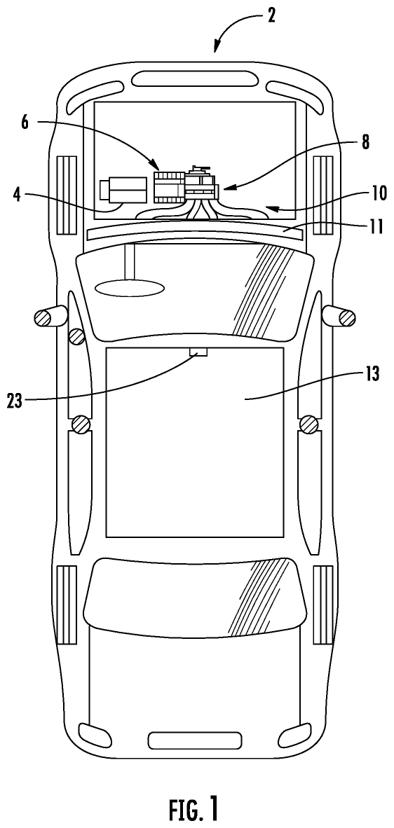

FIG. 1 depicts an air handling system 10 employed in an exemplary HVAC system 8 for a vehicle 2, which may be an electric or hybrid electric vehicle powered by a battery 4. The air handling system 10 disclosed herein is exemplary in nature and a method for the controlling the air handling system 10, as described hereinafter, may be employed with various other air handling systems as desired. It is understood that the method for the air handling system 10 may be utilized in any type of vehicle including a vehicle utilizing an internal combustion engine without departing the scope of the present disclosure. It is further understood that the air handling system 10 and control method may be utilized in any type of system application that requires regulating multiple airflow paths. A controller 6 may in communication with the HVAC system 8, and particularly the air handling system 10, to implement the method. In some instances, the HVAC system 8 may further include at least one humidity sensor 23 disposed within a passenger cabin or compartment 13 of the vehicle 2 to detect a humidity level therein. It is understood that the humidity sensor 23 may be any suitable humidity sensor as desired. The humidity sensor 23 may also be in communication with the controller 6 to transmit a signal representative of the humidity level thereto for use in the control method for air handling optimization. It should also be appreciated that during operation of the vehicle 2, ram air conditions and pressures are generated. For example, when the vehicle 2 is traveling at about 33 miles per hour, a ram pressure at a front of the vehicle 2 is about 133 Pa, a ram pressure at a cowl 11 of the vehicle 2 is about 50 Pa, and a ram pressure in the passenger compartment 13 of the vehicle 2 is about 0 Pa. It should be appreciated that the ram air conditions and pressures are dynamic and change as the speed of the vehicle 2 increases and decreases.

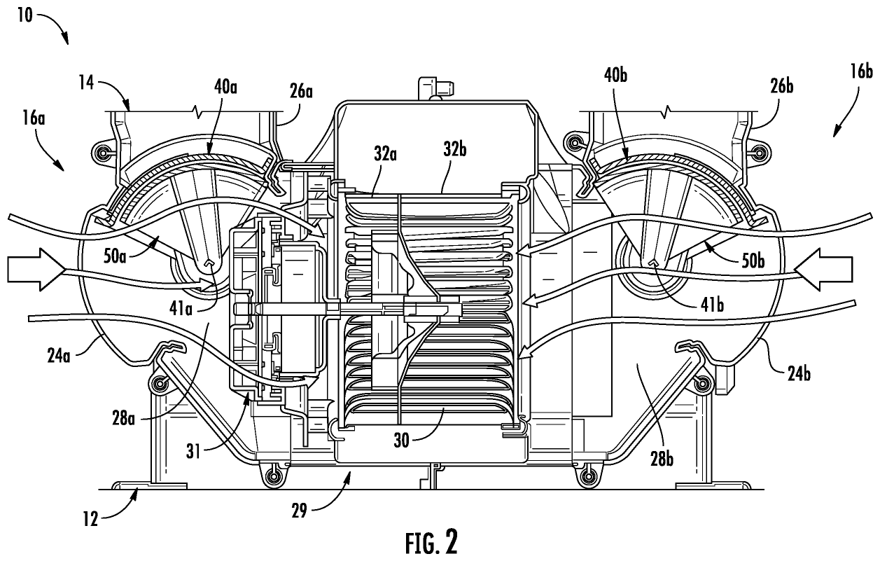

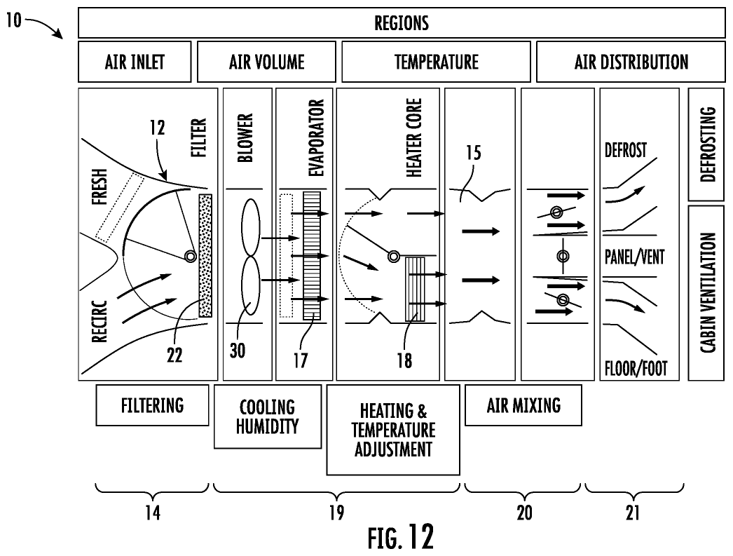

FIGS. 2-8 and 12 illustrate the air handling system 10 in accordance with an exemplary embodiment of the present disclosure. As shown, the air handling system 10 may include a housing 12 defining a flow path 15 for the air to pass through when being conditioned for distribution to the passenger compartment 13 of the associated vehicle 2. An evaporator 17 for cooling and/or a heater core 18 for heating (depicted in FIG. 12) may be disposed in the flow path 15 defined by the housing 12 to condition the air. The air handling system 10 may include an inlet section 14 wherein air is first introduced into the housing 12. In some embodiments, the housing 12 further defines a conditioning section 19 of the air handling system 10 disposed downstream of the inlet section 14 for heating and/or cooling the air, a mixing section 20 of the air handling system 10 disposed downstream of the conditioning section 19 for mixing the heated and/or cooled air, and a distribution section 21 of the air handling system 10 disposed downstream of the mixing section 20 where the mixed air is distributed to flow paths leading to vents directed toward the passenger compartment 13 of the vehicle 2. The evaporator 17 and/or the heater core 18 may be located in the conditioning section 19 of the air handling system 10, if desired.

Referring back to FIGS. 2-8, the inlet section 14 may be comprise a first inlet portion 16a and a second inlet portion 16b. The first inlet portion 16a may include a first recirculation air inlet 24a and a first ambient or fresh air inlet 26a. Similarly, the second inlet portion 16b may include a second recirculation air inlet 24b and a second ambient or fresh air inlet 26b. The recirculation air inlets 24a, 24b may be in fluid communication with the passenger compartment 13 of the vehicle 2 and configured to provide a flow path for previously conditioned air to return to the housing 12 for additional heating or cooling within the conditioning section of the housing 12. A suitable conduit or the like (not depicted) may be utilized to fluidly couple the passenger compartment 13 to the recirculation air inlets 24a, 24b as desired. The ambient air inlets 26a, 26b may be in fluid communication with the ambient environment surrounding the vehicle 2 and may be configured to provide a flow path for ambient air to be first introduced into the housing 12 for heating or cooling within the conditioning section of the housing 12. In some embodiments, the cowl 11 of the vehicle 2 and/or other similar conduit may be utilized to fluidly connect the ambient environment outside of the vehicle 2 to the ambient air inlets 26a, 26b, as desired.

The housing 12 may further include a first blower flow path 28a and a second blower flow path 28b disposed within a respective one of the inlet portions 16a, 16b downstream of the recirculation air inlets 24a, 24b and the ambient air inlets 26a, 26b. The blower flow paths 28a, 28b lead to a blower assembly 29 disposed within the housing 12 between the first inlet portion 16a and the second inlet portion 16b. The blower assembly 29 may be configured to generate a pressure difference (i.e. a suction pressure) for drawing the recirculation air and the ambient air into the inlet section 14.

The blower assembly 29 may include a rotary blower wheel 30 for generating the pressure difference, as desired. The associated blower wheel 30 may be drivingly coupled to an electric motor 31 and configured to operate at a plurality of different rotational speeds as established by a selection of a passenger of the vehicle 2 and/or the controller 6 in communication with the HVAC system 8, wherein each of the different rotational speeds is associated with a different flow rate of the air through the remainder of the air handling system 10 at positions downstream of the blower assembly 29. Various types of blower wheels 30 may be employed. The blower wheel 30 may be divided into a first portion 32a and a second portion 32b. The portions 32a, 32b of the blower wheel 30 may be integrally formed as a unitary structure or as separate and distinct components. In certain embodiments, the first portion 32a and the second portion 32b of the blower wheel 30 may be substantially similar or the same size. In other embodiments, however, the first portion 32a may be relatively smaller than the second portion 32a. For example, the first portion 32a may comprise less than 50% of the entire blower wheel 30, preferably about 25% thereof, and the second portion 32b may comprise more than 50% of the entire blower wheel 30, preferably about 75% thereof. In some embodiments, the first portion 32a of the blower wheel 30 may be associated with the ambient air and the second portion 32b may be associated with the recirculation air, or vice versa.

The air flowing through the first blower flow path 28a may be separated from the air flowing through the second blower flow path 28b prior to being drawn into the blower assembly 29. At a relatively low recirculation requirement of the embodiments of the air handling system 10 employing the blower wheel 30 having differently sized portions 32a, 32b, the smaller first portion 32a associated with ambient air must work harder to achieve a desired flow rate of the air being delivered to the passenger compartment 13, which requires an increase in a rotational speed of the blower wheel 30. In other embodiments, however, the blower flow paths 28a, 28b may in fluid communication with each other through one or more openings 34 formed in the housing 12. The one or more openings 34 may permit a crossflow of the air flowing through the first blower flow path 28a and the air flowing through the second blower flow path 28b, which thereby allows the air to mix prior to being drawn into the blower assembly 29. A valve such as a one-way valve may be disposed in each of the one or more openings 34 to selectively control an amount and a direction of the crossflow. By permitting the crossflow, the flow of air into the differently-sized portions 32a, 32b of the blower wheel 30 may be more balanced so that the desired flow rate of the air being delivered to the passenger compartment 13 may be reached at a lower blower speed, which reduces energy consumption of the HVAC system 8.

One or more fluid filters 22 (depicted in FIG. 12) may also be disposed within the inlet section 14 of the housing 12 of the air handling system 10 to remove any debris from the air that could otherwise flow through the housing 12 before eventually reaching the passenger compartment 13 of the vehicle 2. In some embodiments, the one or more fluid filters 22 may be disposed in the ambient air inlets 26a, 26b (shown in dashed lines in FIG. 12), each of the blower flow paths 28a, 28b, and/or downstream of the blower assembly 29 (also shown in dashed lines in FIG. 12), extending across an entirety of a flow cross-section thereof. The one or more fluid filters 22 may be configured to allow for the passage of the air therethrough, but yet rigid and solid in a manner wherein the fluid filter 22 may function as a stopping mechanism or resting surface. It should be understood that the passage of air through the fluid filter 22 may lower the pressure of the air as a result of the flow obstruction provided by the fluid filter 22 in a manner resisting the back-flow of the air in a direction upstream of the fluid filter 22 after the air has passed therethrough.

As illustrated, the first inlet portion 16a may further include a first distribution door 40a and a first baffle door 50a for controlling the flow of the air through each of the first recirculation air inlet 24a and the first ambient air inlet 26a. Similarly, the second inlet portion 16b may further include a second distribution door 40b and a second baffle door 50b for controlling the flow of the air through each of the second recirculation air inlet 24b and the second ambient air inlet 26b. The distribution doors 40a, 40b and the baffle doors 50a, 50b are shown in substantially simplified fashion in the illustrated air handling system 10.

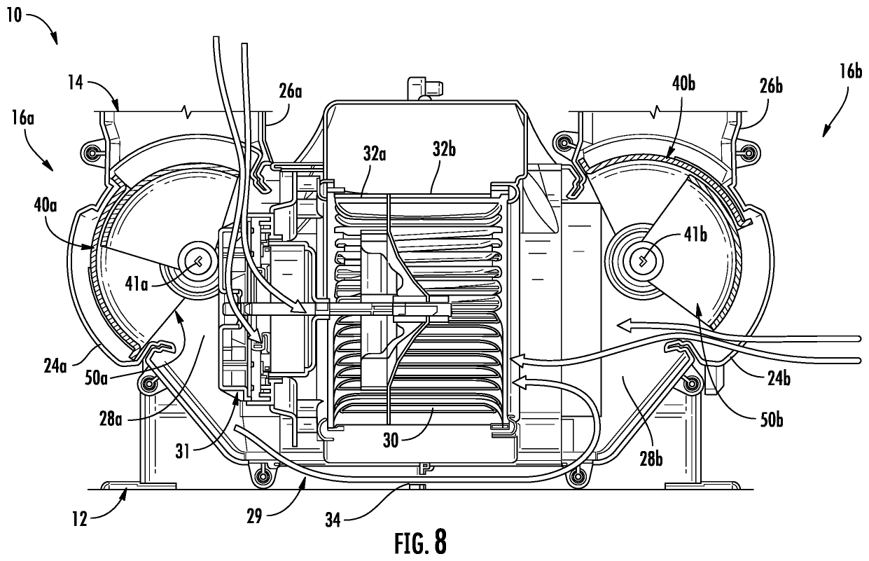

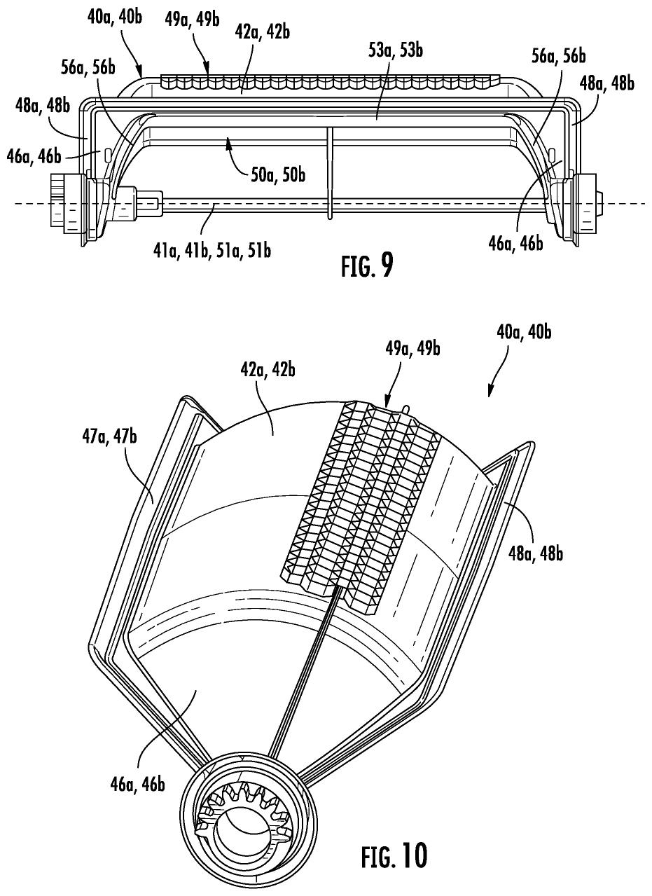

As more clearly shown in FIGS. 9 and 10, the first distribution door 40a may include an axis of rotation 41a defined by a suitable shaft, shaft portions, or similar structures, an air directing wall 42a, and a pair of lateral connecting walls 46a connecting the air directing wall 42a to the structures defining the axis of rotation 41a at opposing lateral ends of the air directing wall 42a. The first distribution door 40a further may include a first sealing element 47a formed around a first peripheral portion of the first distribution door 40a including the lateral connecting walls 46a and a first end of the air directing wall 42a and a second sealing element 48a formed around a second peripheral portion of the first distribution door 40a including the lateral connecting walls 46a and a second end of the air directing wall 42a. In certain embodiments, the sealing elements 47a, 48a are configured to engage a corresponding wall portion of the housing 12 in a sealing fashion. As shown, the air directing wall 42a may have a substantially constant radius of curvature as measured from the axis of rotation 41a of the first distribution door 40a.

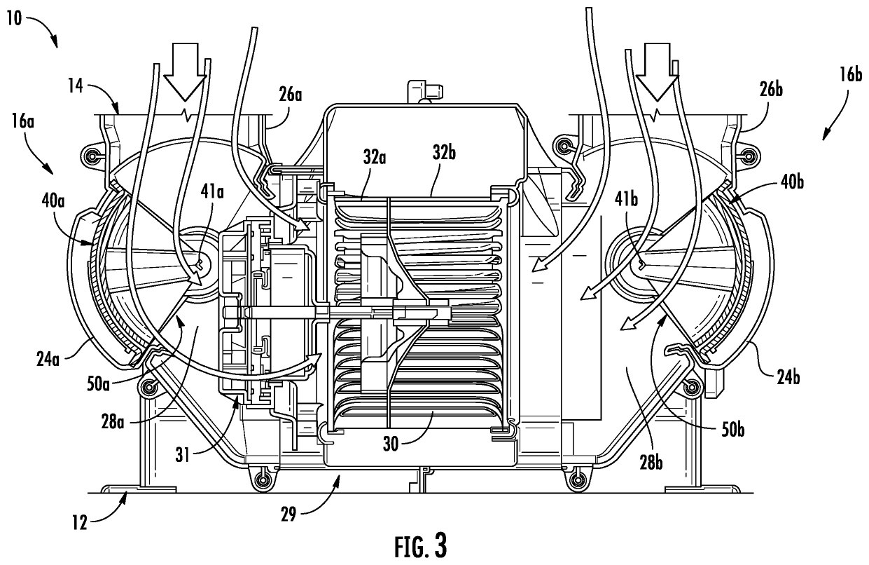

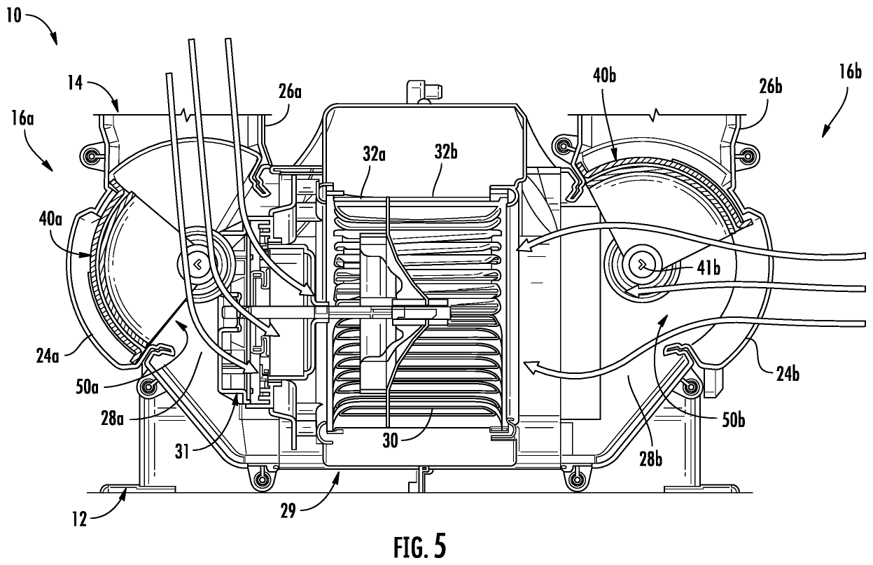

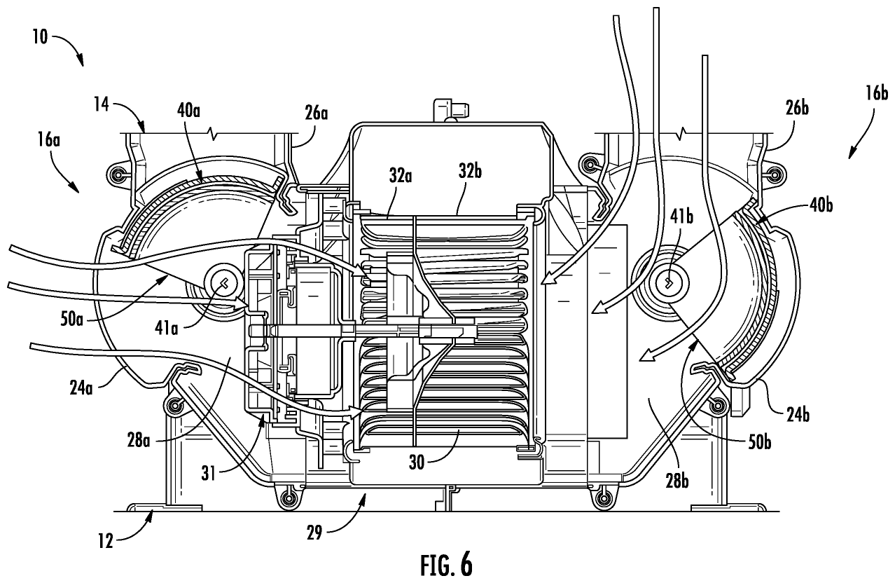

In certain embodiments, the first distribution door 40a is selectively positionable or adjustable between a first position (depicted in FIGS. 2 and 6) and a second position (depicted in FIGS. 3-5 and 7 and 8). In the first position, the first distribution door 40a substantially closes the first ambient air inlet 26a to militate against a flow of the ambient air therethrough and substantially opens the first recirculation air inlet 24a to permit a flow of the recirculation air therethrough. In the second position, the first distribution door 40a substantially opens the first ambient air inlet 26a to permit a flow of the ambient air therethrough and substantially closes the first recirculation air inlet 24a to militate against a flow of the recirculation air therethrough. The first distribution door 40a may be further selectively positionable or adjustable to a plurality of intermediate positions between the first and second positions for regulating the flow of the recirculation air through the first recirculation air inlet 24a and the flow of the ambient air through the first ambient air inlet 26a to optimize performance, effectiveness, and efficiency of the HVAC system 8.

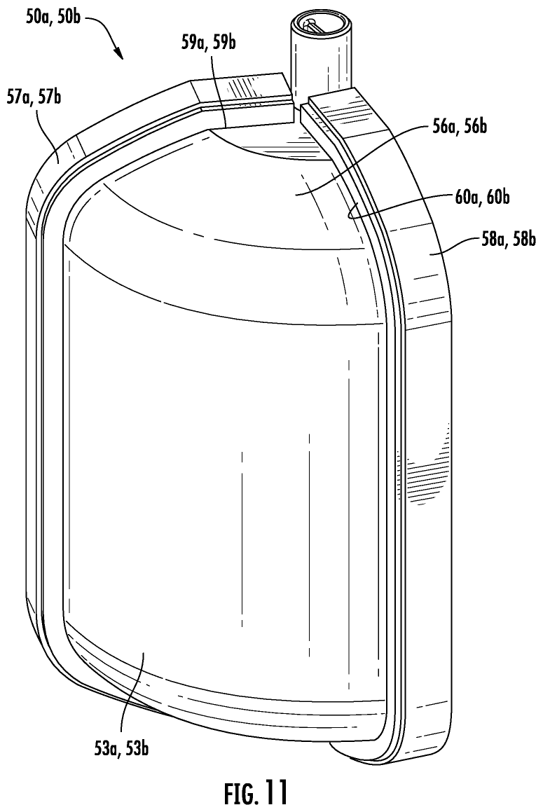

The first baffle door 50a may include an axis of rotation 51a that coincides with the axis of rotation 41a of the first distribution door 40a. As illustrated in FIG. 11, the first baffle door 50a may include a baffle wall 53a that may include a constant radius of curvature as measured from the axis of rotation 51a of the first baffle door 50a. The baffle wall 53a may include a smaller radius of curvature than the first distribution door 40a to form a radial gap between the doors 40a, 50a. The baffle door 50a may further include an opposing pair of lateral connecting walls 56a connecting the baffle wall 53a to the shaft, shaft portions, or similar shaft structure defining the axis of rotation 51a of the baffle door 50a. The lateral connecting walls 56a are tapered laterally inwardly as the lateral connecting walls 56a extend away from the axis of rotation 51a and towards the baffle wall 53a and may further include a slightly arcuate shape.

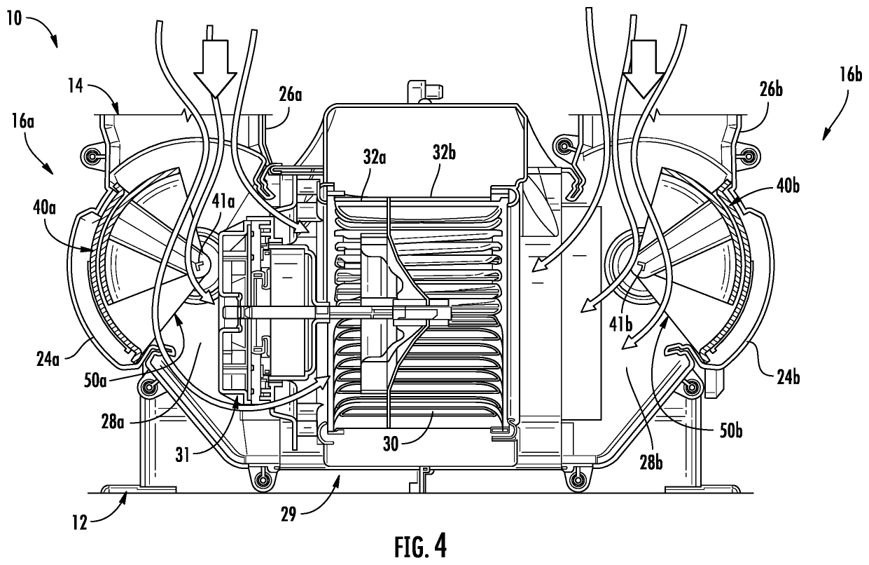

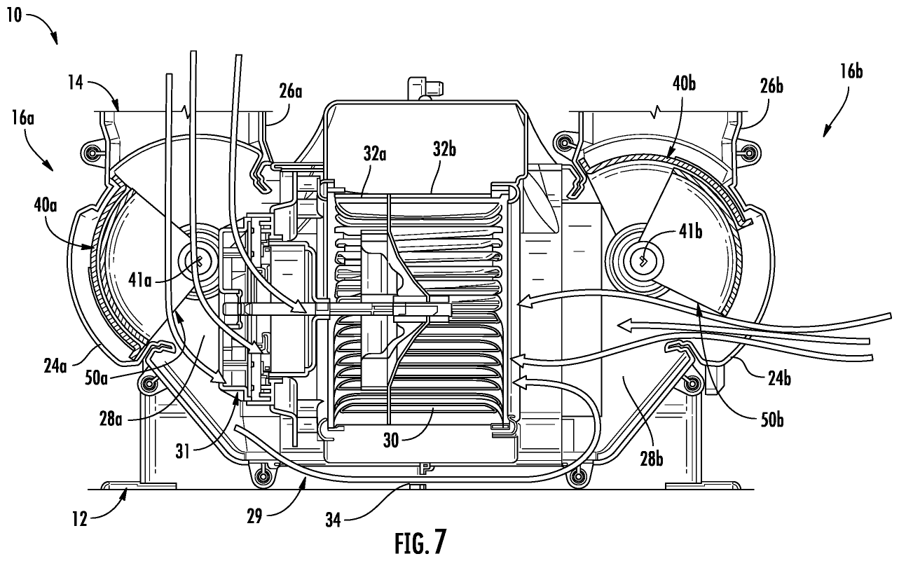

In certain embodiments, the first baffle door 50a is selectively positionable or adjustable between a first position (depicted in FIGS. 2 and 6) and a second position (depicted in FIGS. 3, 5, and 7). In the first position, the first baffle door 50a substantially closes the first ambient air inlet 26a to militate against a flow of the ambient air therethrough and substantially opens the first recirculation air inlet 24a to permit a flow of the recirculation air therethrough. In the second position, the first baffle door 50a substantially opens the first ambient air inlet 26a to permit a flow of the ambient air therethrough and substantially closes the first recirculation air inlet 24a to militate against a flow of the recirculation air therethrough. The first baffle door 50a may be further selectively positionable or adjustable to a plurality of intermediate positions between the first and second positions for regulating the flow of the recirculation air through the first recirculation air inlet 24a and the flow of the ambient air through the first ambient air inlet 26a to further optimize performance, effectiveness, and efficiency of the HVAC system 8. Two of the intermediate positions of the first baffle door 50a are depicted in FIGS. 4 and 8. It is understood, however, that numerous intermediate positions of the first baffle door 50a are possible, for example, a similar position of that of the second baffle door 50b shown in FIG. 7.

Similar to the first distribution door 40a, the second distribution door 40b, as shown in FIGS. 9 and 10, may include an axis of rotation 41b defined by a suitable shaft, shaft portions, or similar structures, an air directing wall 42b, and a pair of lateral connecting walls 46b connecting the air directing wall 42b to the structures defining the axis of rotation 41b at opposing lateral ends of the air directing wall 42b. The second distribution door 40b further may include a first sealing element 47b formed around a first peripheral portion of the second distribution door 40b including the lateral connecting walls 46b and a first end of the air directing wall 42b and a second sealing element 48b formed around a second peripheral portion of the second distribution door 40b including the lateral connecting walls 46b and a second end of the air directing wall 42b. In certain embodiments, the sealing elements 47b, 48b are configured to engage a corresponding wall portion of the housing 12 in a sealing fashion. As shown, the air directing wall 42b may have a substantially constant radius of curvature as measured from the axis of rotation 41b of the second distribution door 40b.

In certain embodiments, the second distribution door 40b is selectively positionable or adjustable between a first position (depicted in FIGS. 2, 5, 7, and 8) and a second position (depicted in FIGS. 3, 4, and 6). In the first position, the second distribution door 40b substantially closes the second ambient air inlet 26b to militate against a flow of the ambient air therethrough and substantially opens the second recirculation air inlet 24b to permit a flow of the recirculation air therethrough. In the second position, the second distribution door 40b substantially opens the second ambient air inlet 26b to permit a flow of the ambient air therethrough and substantially closes the second recirculation air inlet 24b to militate against a flow of the recirculation air therethrough. The second distribution door 40b may be further selectively positionable or adjustable to a plurality of intermediate positions between the first and second positions for regulating the flow of the recirculation air through the second recirculation air inlet 24b and the flow of the ambient air through the second ambient air inlet 26b to optimize performance, effectiveness, and efficiency of the HVAC system 8.

As illustrated in FIG. 11, the second baffle door 50b (similar to the first baffle door 50a) may include an axis of rotation 51b that coincides with the axis of rotation 41b of the second distribution door 40b. The second baffle door 50b may include a baffle wall 53b that may include a constant radius of curvature as measured from the axis of rotation 51b of the second baffle door 50b. The baffle wall 53b may include a smaller radius of curvature than the second distribution door 40b to form a radial gap between the doors 40b, 50b. The baffle door 50b may further include an opposing pair of lateral connecting walls 56b connecting the baffle wall 53b to the shaft, shaft portions, or similar shaft structure defining the axis of rotation 51b of the baffle door 50b. The lateral connecting walls 56b are tapered laterally inwardly as the lateral connecting walls 56b extend away from the axis of rotation 51b and towards the baffle wall 53b and may further include a slightly arcuate shape.

In certain embodiments, the second baffle door 50b is selectively positionable or adjustable between a first position (depicted in FIGS. 2 and 5) and a second position (depicted in FIGS. 3 and 6). In the first position, the second baffle door 50b substantially closes the second ambient air inlet 26b to militate against a flow of the ambient air therethrough and substantially opens the second recirculation air inlet 24b to permit a flow of the recirculation air therethrough. In the second position, the second baffle door 50b substantially opens the second ambient air inlet 26b to permit a flow of the ambient air therethrough and substantially closes the second recirculation air inlet 24b to militate against a flow of the recirculation air therethrough. The second baffle door 50b may be further selectively positionable or adjustable to a plurality of intermediate positions between the first and second positions for regulating the flow of the recirculation air through the second recirculation air inlet 24b and the flow of the ambient air through the second ambient air inlet 26b to further optimize performance, effectiveness, and efficiency of the HVAC system 8. Three of the intermediate positions of the second baffle door 50b are depicted in FIGS. 4, 7, and 8. It is understood, however, that numerous intermediate positions of the second baffle door 50b are possible.

The first and second distribution doors 40a, 40b may each be swing/barrel type doors having low sensitivity to leaks and deformation caused by the pressure differentials generated within the inlet section 14. In certain embodiments, the first and second baffle doors 50a, 50b may not include sealing elements about peripheral surfaces thereof, hence the baffle doors 50a, 50b are able to independently move between the first and second positions without interference with the associated distribution doors 40a, 40b and regardless of the position thereof.

In some embodiments, each of the baffle doors 50a, 50b, when in the first and/or second positions thereof, may be configured to sealingly engage the associated distribution doors 40a, 40b and a corresponding wall portion of the housing 12 to reduce an incidence of noise, vibration, and harshness (NVH) and/or militate against an undesired leakage or flow of the ambient air and/or the recirculation air around the baffle doors 50a, 50b. Accordingly, the air handling system 10 may be able to more effectively regulate the flow of the recirculation air and the flow of the ambient air through the inlets 24a, 24b, 26a, 26b to further optimize performance, effectiveness, and efficiency of the HVAC system 8. It should be appreciated that the sealing engagement may be achieved using various types of sealing methods such as separately affixed sealing elements, over-molded sealing elements, integrally formed sealing elements and/or regions, and the like, for example.

Each of the doors 40a, 40b, 50a, 50b located within the air handling system 10 may be independently moved and selectively positioned in a plurality of different positions to achieve a plurality of different modes of operation of the air handling system 10. The distribution of air entering the air handling system 10 from the recirculation air inlets 24a, 24b and the ambient air inlets 26a, 26b may be controlled using each of the distribution doors 40a, 40b and/or each of the baffle doors 50a, 50b based on a mode of operation of the air handling system 10 as selected by a passenger of the vehicle 2, such as a fresh or ambient air mode or a recirculation air mode. In some embodiments, the air handling system 10 may further include a user-selectable partial-recirculation mode, or alternatively the partial-recirculation mode may be automatically selected by the controller 6 associated with the air handling system 10 and responsible for actuating the distribution doors 40a, 40b and the baffle doors 50a, 50b in accordance with various conditions experienced by the vehicle 2, as explained hereinafter.

The distribution doors 40a, 40b and the baffle doors 50a, 50b may be adjusted by a kinematics system having one or more actuators in signal communication with the controller 6 as described herein. It should be appreciated that a wide variety of kinematics systems may be appropriate for adjusting the doors 40a, 40b, 50a, 50b in the manner described hereinabove. However, alternative methods of rotating the doors 40a, 40b, 50a, 50b may be utilized without necessarily departing from the scope of the present invention. For example, each of the doors 40a, 40b, 50a, 50b may be associated with an independent actuator with each of the actuators activated by the corresponding controller 6 independently. Such a configuration advantageously allows for even more operational modes to be achieved without restricting the position of one of the doors 40a, 40b, 50a, 50b relative to the other of the doors 40a, 40b, 50a, 50b. It is also understood that alternative control methods may be utilized while remaining within the scope of the present invention so long as the doors 40a, 40b, 50a, 50b are able to accommodate the varying vehicle speeds, ram air pressures, humidity levels, rotational speeds of the blower wheel 30, or other conditions faced within the air handling system 10 as described herein.

Referring back to FIG. 2 which illustrates a recirculation mode of operation of the air handling system 10 wherein the first distribution door 40a and a first baffle door 50a are in the first positions to militate against the flow of the ambient air through the ambient air inlet 26a while permitting the flow of the recirculation air through the first recirculation air inlet 24a of the inlet section 14. The second distribution door 40b and the second baffle door 50b are also in the first positions to militate against the flow of the ambient air through the second ambient air inlet 26b while permitting the flow of the recirculation air through the second recirculation air inlet 24b of the inlet section 14. The positions of the distribution doors 40a, 40b and the baffle doors 50a, 50b allow for the recirculation air entering through the recirculation air inlets 24a, 24b to flow through the blower flow paths 28a, 28b and into the blower assembly 29 without substantial inference from the doors 40a, 40b, 50a, 50b, thereby preventing an undesired pressure drop in the air passing through the inlet section 14 of the air handling system 10.

FIG. 3. illustrates the inlet section 14 when operated in an ambient air mode of operation of the air handling system 10 with the first distribution door 40a and the first baffle door 50a in the second positions to permit the flow of the ambient air through the first ambient air inlet 26a and militate against the flow of the recirculation air through the first recirculation air inlet 24a of the inlet section 14, and the second distribution door 40b and the second baffle door 50b in the second positions to permit the flow of the ambient air through the second ambient air inlet 26b and militate against the flow of the recirculation air through the second recirculation air inlet 24b of the inlet section 14. The positions of the doors 40a, 40b, 50a, 50b allows for the ambient air to pass through the inlet section 14 of the air handling system 10 without experiencing an undesired pressure drop.

FIG. 4 illustrates a mode of operation of the inlet section 14 a restricted ambient air mode of operation of the air handling system 10, wherein the ram air pressure generated by motion of the vehicle 2 is accommodated by restricting the flow area through the ambient air inlet 26 when the ambient air mode of operation is selected by the passenger of the vehicle 2. The first distribution door 40a is in the second position to militate against the flow of the recirculation air through the first recirculation air inlet 24a of the inlet section 14 and the first baffle door 50a in an intermediate position towards the first position to permit a constricted flow of the ambient air through the first ambient air inlet 26a of the inlet section 14. The second distribution door 40b is in the second position to militate against the flow of the recirculation air through the second recirculation air inlet 24b of the inlet section 14 and the second baffle door 50b is in an intermediate position towards the first position to permit a constricted flow of the ambient air through the second ambient air inlet 26b of the inlet section 14. The intermediate positions of the baffle doors 50a, 50b may be varied depending on the speed of the vehicle 2 and hence the resulting ram air pressure of the ambient air entering through the ambient air inlets 26a, 26b, wherein the flow of the ambient air through the ambient air inlets 26a, 26b may be reduced as the ram air pressure increases due to an increase in vehicle speed.

FIGS. 5-7 illustrate a partial ambient air and partial recirculation air mode of operation of the air handling system 10, which may alternatively be referred to as the partial recirculation mode of operation of the air handling system 10 using a conventional method for controlling the air handling system 10. It should be appreciated that FIGS. 5-7 are illustrative examples, and the doors 40a, 40b, 50a, 50b may be selectively positioned in many different configurations and should not construed as limited to the embodiments set forth herein. When the air handling system 10 is operating in the partial recirculation mode, each of the doors 40a, 40b, 50a, 50b may be in the first position to militate against the flow of the ambient air through a respective one of the ambient air inlets 26a, 26b while permitting the flow of the recirculation air through the recirculation air inlets 24a, 24b and/or the second position to permit the flow of the ambient through a respective one of the ambient air inlets 26a, 26b while militating against the flow of the recirculation air through the recirculation air inlets 24a, 24b, and/or a plurality of intermediate positions between the first and second positions to restrict the flow of the recirculation air through a respective one of the recirculation air inlets 24a, 24b and/or the flow of the ambient air through a respective one of the ambient air inlets 26a, 26b.

The alternative intermediate positions of the doors 40a, 40b, 50a, 50b may be required to maintain a desired distribution of the air originating from the recirculation air inlets 24a, 24b and the ambient air inlets 26a, 26b. For example, as the speed of the vehicle 2 increases, a ram air pressure at the cowl 13 and generated within the ambient air inlets 26a, 26b may increase in a manner causing the ambient air to enter the inlet section 14 at a greater flow rate than the air entering the recirculation air inlets 24a, 24b, thereby interrupting the desired distribution of the air between the inlets 24a, 24b, 26a, 26b. The distribution doors 40a, 40b may accordingly be rotated a first direction towards or into the first position to reduce a cross-section of the flow of the ambient air passing by the distribution doors 40a, 40b originating from the ambient air inlets 26a, 26b in order to cause a corresponding reduction of the flow of the ambient air into the inlet section 14. In contrast, the distribution doors 40a, 40b may be rotated in an opposite second direction towards or into the second position when it may be desired for a greater distribution of the ambient air into the passenger compartment 13.

FIG. 5 shows the air handling system 10 in the partial recirculation mode of operation with the first distribution door 40a and the first baffle door 50a in second positions to permit the flow of the ambient air through the first ambient air inlet 26a and militate against the flow of the recirculation air through the first recirculation air inlet 24a of the inlet section 14, and the second distribution door 50b and the second baffle door 50b in the first positions to militate against the flow of the ambient air through the second ambient air inlet 26b and permit the flow of the recirculation air through the second recirculation air inlet 24b of the inlet section 14. In some embodiments and as a non-limiting example, the partial recirculation mode of operation of the air handling system 10 shown in FIG. 5 may be employed during various states of the vehicle (e.g., an idle state; low-speed, low-ram air pressure state) to provide a desired distribution the ambient air and the recirculation air within the inlet section 14.

FIG. 6 depicts the air handling system 10 in the partial recirculation mode of operation with the first distribution door 40a and the first baffle door 50a in the first positions to militate against the flow of the ambient air through the first ambient air inlet 26a and permit the flow of the recirculation air through the first recirculation air inlet 24a of the inlet section 14, and the second distribution door 40b and the second baffle door 50b in the second positions to permit the flow of the ambient air through the second ambient air inlet 26b and militate against the flow of the recirculation air through the second recirculation air inlet 24b of the inlet section 14. In some embodiments and as a non-limiting example, the partial recirculation mode of operation of the air handling system 10 shown in FIG. 6 may be employed during various states of the vehicle (e.g., an idle state; low-speed, low-ram air pressure state) to provide a desired distribution the ambient air and the recirculation air within the inlet section 14.

FIG. 7 shows the air handling system 10 in the partial recirculation mode of operation with the first distribution door 40a and the first baffle door 50a in the second positions to permit the flow of the ambient air through the first ambient air inlet 26a and militate against the flow of the recirculation air through the first recirculation air inlet 24a of the inlet section 14, and the second distribution door 40b in the first position to militate against the flow of the ambient air through the second ambient air inlet 26b and the second baffle door 50b in an intermediate position towards the second position to permit a constricted flow of the recirculation air through the second recirculation air inlet 24b of the inlet section 14. In some embodiments and as a non-limiting example, the partial recirculation mode of operation of the air handling system 10 shown in FIG. 7 may be employed during various states of the vehicle (e.g., an idle state; low-speed, low-ram air pressure state) to provide a desired distribution the ambient air and the recirculation air within the inlet section 14.

It is understood that the air handing system 10 in the partial recirculation mode of operation may also include configurations wherein the first distribution door 40a is in the first position to militate against the flow of the ambient air through the first ambient air inlet 26a of the inlet section 14 and the first baffle door 50a is in one of an intermediate position or the second position to permit a constricted flow or militate against the flow, respectively, of the recirculation air through the first recirculation air inlet 24a of the inlet section 14, and the second distribution door 40b is in the second position to militate against the flow of the recirculation air through the second recirculation air inlet 24b of the inlet section 14 and the second baffle door 50b is in one of the first position, the second position, or an intermediate position to militate against the flow, permit an unrestricted flow, or a constricted flow, respectively, of the ambient air through the second ambient air inlet 26b of the inlet section 14.

FIG. 8 illustrates the partial recirculation mode of operation of the air handling system 10 using a method for controlling the air handling system 10 according to an embodiment of the present disclosure. In particular, when operating in the partial recirculation mode of the present disclosure, the first distribution door 40a is in the second position to militate against the flow of the recirculation air through the first recirculation air inlet 24a of the inlet section 14 and the first baffle door 50a is in the intermediate position towards the first position to permit a constricted flow of the ambient air through the first ambient air inlet 26a of the inlet section and the second distribution door 40b is in the first position to militate against the flow of the ambient air through the second ambient air inlet 26b of the inlet section 14 and the second baffle door 50b is in an intermediate position to permit a constricted flow of the recirculation air through the second recirculation air inlet 24b of the inlet section 14.

In preferred embodiments, the method for controlling the air handling system 10 is used to adjust a conditioning of air flowing through the air handling system 10 to optimize performance, effectiveness, and efficiency of the HVAC system 8. The method maintains a desired humidity level and dew point temperature in the passenger compartment 13 of the vehicle 2 as well as minimizes an amount of energy required by the HVAC system 8. A preferred mode of operation of the air handling system 10 to maximize the performance, effectiveness, and efficiency of the HVAC system 8 is in the full recirculation mode (shown in FIG. 2), which uses no ambient air in the total airflow supplied to the passenger compartment 13. Oftentimes, however, a percentage of the total airflow into the passenger compartment 13 needs to be ambient air in order to avoid humidity build-up within the vehicle 2, which would otherwise cause fogging of the vehicle windows. Thus, in certain circumstances, the air handling system 10 may need to operate in the partial recirculation modes described hereinabove. As such, the method of the present invention regulates the percentages of ambient air and recirculation air in the partial recirculation mode of the air handling system 10 to minimize the amount of energy required by the HVAC system 8. Humidity build-up in the passenger compartment 13 is at least partially dependent on the number of passengers, the percentages of ambient air and the recirculation air from the passenger compartment 13, the rotational speed of the blower wheel 30, and/or the total airflow supplied to the passenger compartment 13 through the HVAC system 8.

A target dew point temperature range is determined based upon a desire to militate against window fogging (where a relatively lower target dew point temperature is preferred) and optimize heating economy (where a relatively higher target dew point temperature is preferred). In some embodiments, the target dew point temperature is in a range of about 5 degrees Celsius (C) below a temperature of ambient air to about 15 degrees C. above the temperature of ambient air. It is understood that the target dew point temperature range may be any suitable range necessary for operation of the air handling system 10 in certain applications. In certain instances, as shown in FIG. 13, the target dew point temperature range is between a target dew point temperature minimum (T_{DEWPT MIN}) of about −10 degrees C. and a target dew point temperature maximum (T_{DEWPT MAX}) of about −5 degrees C. In a non-limiting example, when the vehicle 2 has four occupants and the target dew point temperature of −7.5 degrees C. within the passenger compartment 13 is desired, then a mixture comprising of a 80% relative humidity ambient air at a temperature of −20 degrees C. and an 29% relative humidity recirculation air from the passenger compartment 13 at a temperature of 20 degrees C. is provided to the passenger compartment 13 at a low blower setting, wherein a desired ratio of ambient air to recirculation air is 3:2, the ambient air comprising 60% of a total volume of air provided to the passenger compartment 13 and the recirculation air comprising 40% of the total volume. This mixture of 60% ambient air and 40% recirculation air results in the target dew point of about −7.5 degrees C. and the heater core 18 consumes about 1.36 kW of energy. In comparison, when the vehicle 2 has one occupant and a target dew point temperature of −7.5 degrees C. within the passenger compartment 13 is desired, then the desired ratio of ambient air to recirculation air 3:17 with a mixture comprising of 15% ambient air of total airflow having 80% relative humidity at a temperature of −20 degrees C. and 85% recirculation air of the total airflow having 16% relative humidity at a temperature of 20 degrees C. is provided to the passenger compartment 13. This mixture of 15% ambient air and 85% recirculation air results in the target dew point of about −7.5 degrees C. and the heater core 18 consumes about 0.9 kW of energy. Thus, an increase in the percentage of the recirculation air from the passenger compartment 13 results in a decrease in the amount of energy, for example, heat addition (Q) at the heater core 17, required by the HVAC system 8, to achieve the target dew point temperature. Accordingly, in certain instances, an optimal percentage of the recirculation air from the passenger compartment 13 in the partial recirculation mode of operation along with adjustment of the rotational speed of the blower wheel 30 results in optimal performance of the air handling system 10.

In order to minimize an addition of heat Q at the heater core 17 of the HVAC system 8, and thus, maximize an operating range/a zone of operation of the HVAC system 8, it is desirable to combine an optimal percentage of recirculation air from the passenger compartment 13 with the ambient air being supplied to the passenger compartment 13. The target dew point temperature range, the relative humidity within the passenger compartment 13, the rotational speed of the blower wheel 30, and a percentage of the total airflow for each of the ambient air and the recirculation air are used to arrive at the desired air quality and conditions within the passenger compartment 13, as well as the desired operating range/zone of operation of the HVAC system 8. As described hereinabove, the number of occupants in the passenger compartment 13 of the vehicle 2 may also be taken into account when regulating the amount of ambient air and the recirculation air to achieve the desired air quality and conditions, particularly the actual dew point temperature within the passenger compartment 13.

FIG. 13 graphically shows a desired first zone of control (i.e., the percentage of recirculation air and rotational speed of the blower wheel 30) for a low blower setting of about 30 liters per second and a desired second zone of control (i.e., the percentage of recirculation air and rotational speed of the blower wheel 30) for a high blower setting of about 100 liters per second. Both zones of control are designed to achieve an actual dew point temperature within the passenger compartment 13 that is within the target dew point temperature range (e.g., between −5 degrees C. and −10 degrees C.). In certain embodiments, the zones of control change depending upon the number of occupants in the passenger compartment 13 of the vehicle 2 (or other factors such as wet clothes, snow, etc.), ambient conditions, vehicle speed, and the like.

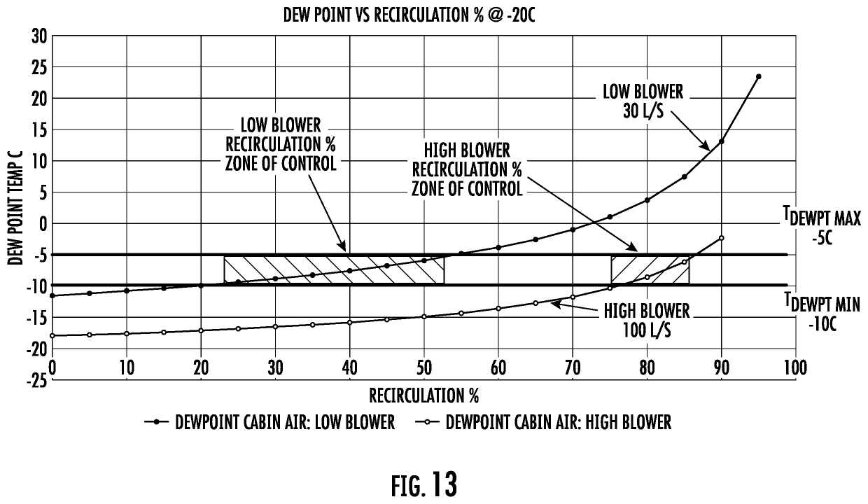

Referring back to FIGS. 7 and 8, which show different positions of the distribution doors 40a, 40b and the baffle doors 50a, 50b during a partial recirculation mode of the air handling system 10 using a conventional method for controlling the air handling system 10 and the positions of the distribution doors 40a, 40b and the baffle doors 50a, 50b during the partial recirculation mode of the air handling system 10 using the inventive method of the present disclosure. As described hereinabove, the conventional partial recirculation mode of the air handling system 10 for a vehicle 2 has the first distribution door 40a and the first baffle door 50a in the second positions to permit the flow of the ambient air through the first ambient air inlet 26a and militate against the flow of the recirculation air through the first recirculation air inlet 24a of the inlet section 14, and the second distribution door 40b in the first position to militate against the flow of the ambient air through the second ambient air inlet 26b and the second baffle door 50b in an intermediate position towards the second position to permit a constricted flow of the recirculation air through the second recirculation air inlet 24b of the inlet section 14. During the partial recirculation mode of the air handling system 10 using the conventional method for controlling the air handling system 10, the air handling system 10 selectively positions the distribution and baffle doors as a vehicle speed increases and decreases to achieve certain air quality and conditions within a passenger compartment 13 of the vehicle 1. Thus, as illustrated in a graph depicted in FIG. 14, a rotational speed of the blower wheel 30 and duty cycle (%) and current (amps) of the blower assembly 29 remains constant as changes in cowl pressure (Pa) occur during the increases and decreases in vehicle speed. As best depicted in FIG. 15, the air handling system 2 operating in the conventional partial air recirculation mode, however, is unable to control a low blower speed and a low recirculation as the ram pressure (e.g., cowl pressure) and/or the vehicle speed increases, and therefore, must employ the fully ambient air mode of operation when such conditions occur. Employing the fully ambient air mode of operation requires more work from the heater core 18, resulting in an increase in energy consumption of the HVAC system 8 and a decrease in efficiency of the vehicle 2.

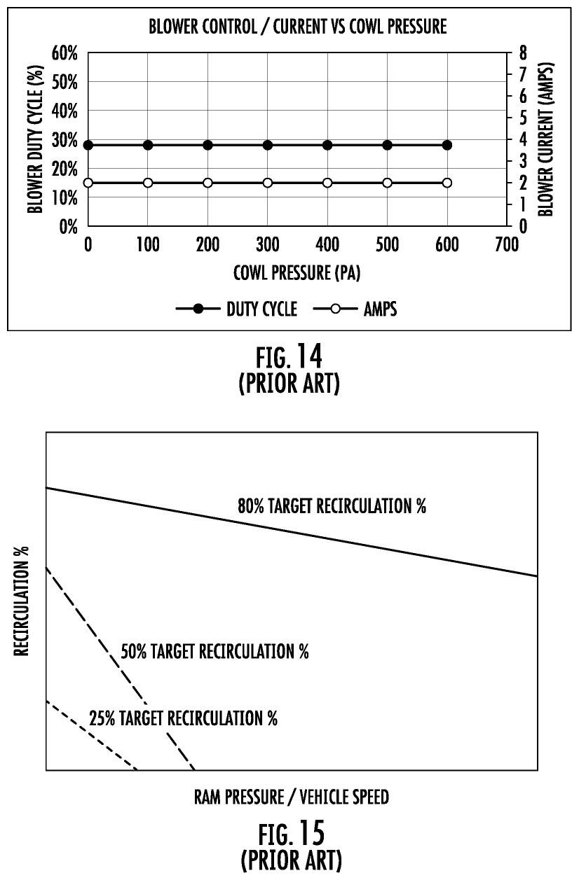

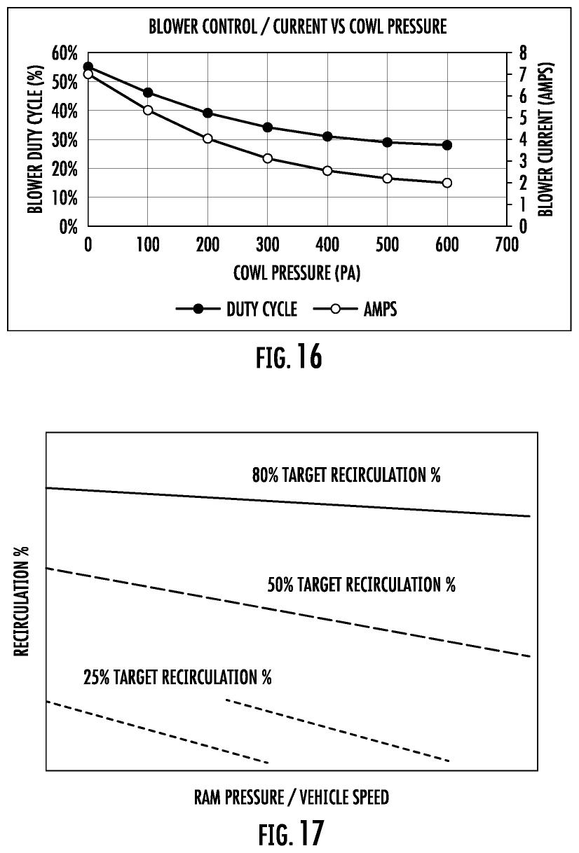

On the contrary, when using the inventive method of the present disclosure, the partial recirculation mode of the air handling system 10 of the vehicle 2, as depicted in FIG. 8, has the first distribution door 40a in the second position, the second distribution door 40b in the first position, and both of the baffle doors 50a, 50b in the intermediate positions (e.g., partially closed), and the air handling system 10 of the present disclosure selectively increases or decreases the rotational speed of the blower wheel 30 to achieve certain air quality and conditions within the passenger compartment 13 of the vehicle 2. Thus, the method of the present disclosure effectively regulates the flow of the recirculation air and the flow of the ambient air through the inlets 24a, 24b, 26a, 26b and compensates with adjustment to the rotational speed of the blower wheel 30 to further optimize performance, effectiveness, and efficiency of the HVAC system 8. It should be appreciated that the adjustment to the rotational speed of the blower wheel 30 of the present disclosure is more advantageous and easily achieved compared to actuation and selectively positioning of the doors 40a, 40b, 50a, 50b in response to changes in conditions (e.g., changes in vehicle speed and cowl pressure). As depicted in FIG. 16, for example, at lower vehicle speeds and cowl pressures (Pa), the rotational speed of the blower wheel 30 may be increased to compensate for a decrease in ram pressure in the cowl 13. The air handling system 2 is then able to control a low blower speed and a low recirculation as the ram pressure (e.g., the cowl pressure) and/or the vehicle speed increases, as depicted in FIG. 17. Thus, the partial recirculation mode of the air handling system 10 of the present disclosure has both of the distribution doors 40a, 40b and the baffle doors 50a, 50b in the intermediate positions, intentionally restricting the flow of the recirculation air and the flow of the ambient air through the inlets 24a, 24b, 26a, 26b, and the air handling system 10 intentionally increases the rotational speed of the blower wheel 30 at lower ram pressures to achieve target air quality and conditions within the passenger compartment 13 of the vehicle 2. Such increase in energy consumption of the HVAC system 8 resulting from the increase in the rotational speed of the blower wheel 30 is more than offset by a decrease in energy consumption of the heater core 18 of the HVAC system 8. Conversely, at higher vehicle speeds and cowl pressures (Pa), the rotational speed of the blower wheel 30 may be decreased to account for an increase in the ram pressure in the cowl 13. Such decrease in the rotational speed of the blower wheel 30 also results in a decrease in the energy consumption of a blower motor.

In embodiments of the present disclosure, the method for controlling the air handling system 10 does not employ continuous changing of the positions (e.g., first, second, and intermediate positions) of the doors 40a, 40b, 50a, 50b to optimize performance, effectiveness, and efficiency of the HVAC system 8. Instead, the controller 6 associated with the actuation of the doors 40a, 40b, 50a, 50b may be pre-programmed with a finite number of positions of the doors 40a, 40b, 50a, 50b and adjusts the rotational speed of the blower wheel 30 to regulate the percentages of ambient air and recirculation air to achieve the target dew point temperature within the passenger compartment 13 during the various operating modes of the air handling system 10. In some embodiments, the controller 6 may be pre-programmed to use only one position for each the distribution doors 40a, 40b and/or the baffle doors 50a, 50b during each of the various operating modes of the air handling system 10. In other embodiments, the method for controlling the air handling system 10 may employ a staggered control method, wherein the controller 6 may be pre-programmed to use two or more positions for the distribution doors 40a, 40b and/or the baffle doors 50a, 50b, at least, during the partial recirculation mode of the air handling system 10 (See e.g., FIG. 17). It should be appreciated, however, that the number of pre-programmed positions for each of the doors 40a, 40b, 50a, 50b during the various operating modes of the air handling system 10 should not be so many as to approach the continuous changing of the positions of the doors 40a, 40b, 50a, 50b since such continuous changing may adversely affect an integrity and durability of the doors 40a, 40b, 50a, 50b, kinematics, and/or actuators of the air handling system 10. The controller 6 may be pre-programmed with data regarding the desired position of the doors 40a, 40b, 50a, 50b and the desired rotational speed of the blower wheel 30 relative to the target dew point temperature range in order to regulate the percentages of ambient air and recirculation air based on the results of experimentation, as desired.

The controller 6 may determine the desired position of the doors 40a, 40b, 50a, 50b and the desired rotational speed of the blower wheel 30 based on one or more known parameters such as a vehicle speed, a humidity level of the air entering or in the passenger compartment 13, a humidity level of the recirculation air entering the recirculation air inlets 24a, 24b, a humidity level of the ambient air entering the ambient air inlets 26a, 26b, a temperature of the ambient air, and/or the number of occupants in the vehicle 2. The partial recirculation mode of operation of the air handling system 10 may be selected by a passenger of the vehicle 2 or may occur as a feature of the control logic programmed into the controller 6 for regulating the flow of the air from the recirculation air inlets 24a, 24b and the ambient air inlets 26a, 26b when either of the recirculation mode or a ambient air mode of operation have been selected by the passenger. The automatic positioning of the distribution doors 40a, 40b and the baffle doors 50a, 50b and the adjustment of the rotational speed of the blower wheel 30 may accordingly be determined to account for the varying ram air pressure experienced within the inlet section 14 or for introducing a desired amount of the ambient air into the inlet section 14 to achieve an actual dew point temperature within the target dew point temperature range for preventing fogging or icing of the windows of the vehicle 2.

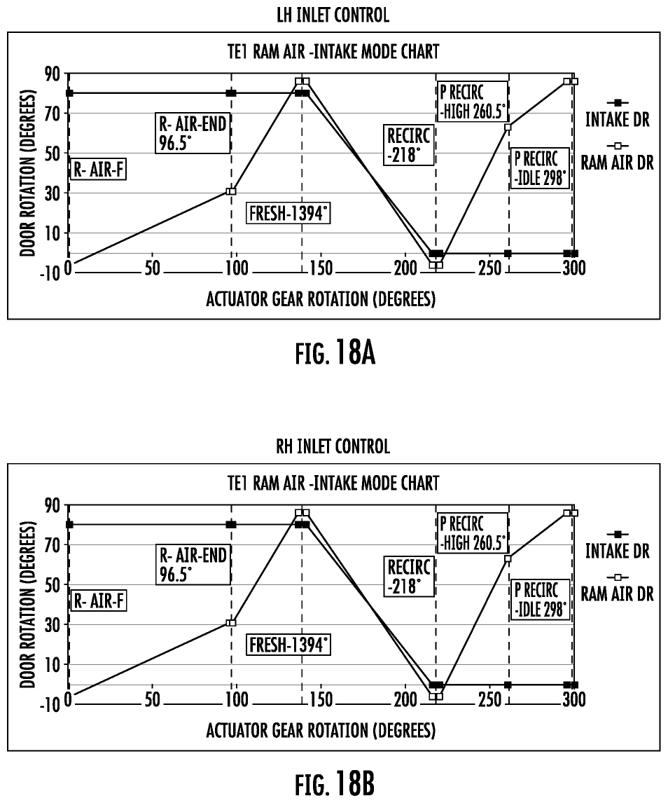

In certain embodiments, the method for controlling the air handling system 10 may further include control of the doors 40a, 40b, 50a, 50b to improve a control of ram/ambient air during the ambient air mode. The control of the doors 40a, 40b, 50a, 50b may be symmetric and uniform, symmetric and non-uniform, and/or asymmetric. FIGS. 18A and 18B are graphs showing the symmetric and uniform control the doors 40a, 40b, 50a, 50b according to an embodiment of the present disclosure. As such, the positions of the doors 40a, 40b, 50a, 50b are the same and synchronously occur. In particular, the positions of the first distribution door 40a (intake dr) and the first baffle door 50a (ram air dr) are shown in the graph of FIG. 18A titled LH Inlet Control. Similarly, the positions of the second distribution door 40b (intake dr) and the second baffle door 50b (ram air dr) are shown in the graph of FIG. 18B titled RH Inlet Control.

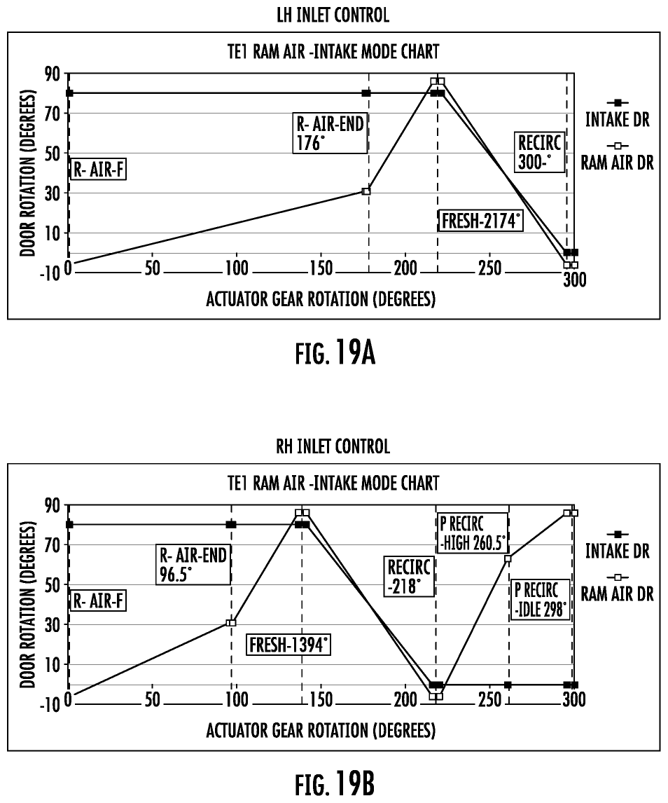

FIGS. 19A and 19B are graphs showing the symmetric and non-uniform control the doors 40a, 40b, 50a, 50b according to another embodiment of the present disclosure. Accordingly, the positions of the doors 40a, 40b, 50a, 50b are same, but occur asynchronously. The positions of the first distribution door 40a (intake dr) and the first baffle door 50a (ram air dr) are shown in the graph of FIG. 19A titled LH Inlet Control and the positions of the second distribution door 40b (intake dr) and the second baffle door 50b (ram air dr) are shown in the graph of FIG. 19B titled RH Inlet Control. In yet another embodiment, the control of the doors 40a, 40b, 50a, 50b may be asymmetric with the positions of the doors 40a, 50a being different from the positons of the doors 40b, 50b. In some instances, one of the baffle doors 50a, 50b, preferably the first baffle door 50a, is selectively positioned to provide refinement to the flow of the ambient air into the inlet section 14 of the air handling system 10. Accordingly, the method for controlling the air handling system 10 including the additional operational control of the doors 40a, 40b, 50a, 50b, as illustrated and described herein, improves a performance of the air handling system 10 in the ambient air mode.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A method of operating an air handling system of a vehicle comprising the steps of:
providing a housing defining an inlet section and a conditioning section downstream of the inlet section, wherein the inlet section includes one or more distribution doors and one or more baffle doors disposed therein to selectively control a flow of recirculation air and a flow of ambient air entering the inlet section, and wherein the conditioning section includes a blower assembly;
selectively positioning at least one of the doors to selectively control the flow of the recirculation air and the ambient air through the inlet section; and
selectively controlling a speed of the blower assembly to achieve a target dew point temperature in a passenger compartment of the vehicle.

2. The method of claim 1, wherein at least one of the doors is in a first position to militate against the flow of the ambient air through the inlet section when the air handling system is operating in a recirculation mode.

3. The method of claim 2, wherein at least one of the doors is in a second position to militate against the flow of the recirculation air through the inlet section when the air handling system is operating in an ambient air mode.

4. The method of claim 3, wherein at least one of the doors is in an intermediate position between the first and second positions to selectively control the flow of the recirculation air and/or the flow of ambient air through the inlet section to achieve a desired ratio of the ambient air to the recirculation air when the air handling system is operating in a partial recirculation mode.

5. The method of claim 3, wherein the doors are in intermediate positions between the first and second positions to selectively control the flow of the recirculation air and the flow of ambient air through the inlet section to achieve a desired ratio of the recirculation air to the ambient air when the air handling system is operating in a partial recirculation mode.

6. The method of claim 1, wherein the selective positioning of the doors is symmetric and uniform when the air handling system is operating in an ambient air mode.

7. The method of claim 1, wherein the selective positioning of the doors is symmetric and non-uniform when the air handling system is operating in an ambient air mode.

8. The method of claim 1, wherein the selective positioning of the doors is asymmetric when the air handling system is operating in an ambient air mode.

9. The method of claim 1, wherein the target dew point temperature is in a range of about 5 degrees Celsius below a temperature of ambient air to about 15 degrees Celsius above the temperature of ambient air.

10. The method of claim 1, wherein the speed of the blower increases as at least one of a speed of the vehicle and a cowl pressure decreases.

11. The method of claim 1, wherein a desired percentage of total airflow of the recirculation air is in a range of about 25% to about 65% when the speed of the blower assembly is relatively low.

12. The method of claim 1, wherein a desired percentage of total airflow of the recirculation air is about 75% to about 85% when the speed of the blower assembly is relatively high.

13. The method of claim 1, wherein a desired percentage of total airflow of the recirculation air increases as the speed of the blower assembly increases.

14. The method of claim 1, wherein the speed of the blower assembly and a ratio of the recirculation air to the ambient air when the air handling system is operating in a partial recirculation mode is determined based upon at least one of a vehicle speed, a humidity level of air within the passenger compartment, a humidity level of conditioned air entering the passenger compartment, a humidity level of the recirculation air entering the recirculation air inlets, a humidity level of the ambient air entering the ambient air inlets, a temperature of the ambient air, and a number of occupants in the vehicle.

15. The method of claim 1, wherein an increase in energy consumption of the air handling system resulting from an increase in the speed of the blower assembly is offset by a decrease in energy consumption of a heater core of the air handling system.

16. The method of claim 1, wherein the doors have a finite number of positions for each operating mode of the air handling system.

17. The method of claim 1, wherein each of the doors has a single position for each operating mode of the air handling system.

18. The method of claim 1, wherein the doors have a plurality of positions for a partial recirculation mode of the air handling system.

19. A method of operating an air handling system of a vehicle comprising the steps of:
providing a housing defining an inlet section and a conditioning section downstream of the inlet section, wherein the inlet section includes a first inlet portion and a second inlet portion, wherein the first inlet portion includes a first recirculation air inlet configured to receive recirculation air originating from a passenger compartment of the vehicle and a first ambient air inlet configured to receive ambient air originating from an ambient environment, wherein the second inlet portion includes a second recirculation air inlet configured to receive recirculation air originating from the passenger compartment of the vehicle and a second ambient air inlet configured to receive the ambient air originating from the ambient environment, wherein the first distribution door and the first baffle door are disposed in the inlet section and configured to selectively control a flow of the recirculation air and the ambient air entering the first inlet portion through the first recirculation air inlet and the first ambient air inlet, wherein the second distribution door and the second baffle door are disposed in the inlet section and configured to selectively control a flow of the recirculation air and the ambient air entering the second inlet portion through the second recirculation air inlet and the second ambient air inlet, and wherein the conditioning section includes a blower assembly;
selectively positioning of at least one of the first distribution door, the second distribution door, the first baffle door, and the second baffle door to selectively control the flow of the recirculation air and the ambient air through the inlet section, wherein:
when the air handling system is operating in a recirculation mode, each of the first distribution door and the first baffle door is in a first position to militate against the flow of the ambient air through the first ambient air inlet and each of the second distribution door and the second baffle door is in a first position to militate against the flow of the ambient air through the second ambient air inlet;
when the air handling system is operating in an ambient air mode, each of the first distribution door and the first baffle door is in a second position to militate against the flow of the recirculation air through the first recirculation air inlet, and the second distribution door and the second baffle door is in a second position to militate against the flow of the recirculation air through the second recirculation air inlet; and
when the air handling system is operating in a partial recirculation mode, at least one of the first distribution door and the first baffle door is in an intermediate position between the first and second positions to selectively control the flow of the recirculation air through the first recirculation air inlet and/or the ambient air through the first ambient air inlet and at least one of the second distribution door and the second baffle door is in an intermediate position between the first and second positions to selectively control the flow of the recirculation air through the second recirculation air inlet and/or the ambient air through the second ambient air inlet; and
selectively controlling a speed of a blower assembly to achieve a target dew point temperature in a passenger compartment of the vehicle.

20. A method of operating an air handling system of a vehicle comprising the steps of:
providing a housing defining an inlet section and a conditioning section downstream of the inlet section, wherein the inlet section includes a first inlet portion and a second inlet portion, wherein the first inlet portion includes a first recirculation air inlet configured to receive recirculation air originating from a passenger compartment of the vehicle and a first ambient air inlet configured to receive ambient air originating from an ambient environment, wherein the second inlet portion includes a second recirculation air inlet configured to receive recirculation air originating from the passenger compartment of the vehicle and a second ambient air inlet configured to receive the ambient air originating from the ambient environment, wherein the first distribution door and the first baffle door are disposed in the inlet section and configured to selectively control a flow of the recirculation air and the ambient air entering the first inlet portion through the first recirculation air inlet and the first ambient air inlet, wherein the second distribution door and the second baffle door are disposed in the inlet section and configured to selectively control a flow of the recirculation air and the ambient air entering the second inlet portion through the second recirculation air inlet and the second ambient air inlet, and wherein the conditioning section includes a blower assembly;
selectively positioning of at least one of the first distribution door, the second distribution door, the first baffle door, and the second baffle door to selectively control the flow of the recirculation air and the ambient air through the inlet section, wherein:
when the air handling system is operating in a recirculation mode, each of the first distribution door and the first baffle door is in a first position to militate against the flow of the ambient air through the first ambient air inlet and each of the second distribution door and the second baffle door is in a first position to militate against the flow of the ambient air through the second ambient air inlet;
when the air handling system is operating in an ambient air mode, each of the first distribution door and the first baffle door is in a second position to militate against the flow of the recirculation air through the first recirculation air inlet, and the second distribution door and the second baffle door is in a second position to militate against the flow of the recirculation air through the second recirculation air inlet; and
when the air handling system is operating in a partial recirculation mode, the first distribution door and the first baffle door are in intermediate position between the first and second positions to selectively control the flow of the recirculation air through the first recirculation air inlet and the ambient air through the first ambient air inlet and the second distribution door and the second baffle door are in intermediate positions between the first and second positions to selectively control the flow of the recirculation air through the second recirculation air inlet and the ambient air through the second ambient air inlet; and
selectively controlling a speed of a blower wheel of a blower assembly to achieve a target dew point temperature in a passenger compartment of the vehicle.
